(19) United States
(12) Patent Application Publication
(10) Pub. No.: US 2010/0245665 A1
(43) Pub. Date: Sep. 30, 2010

(54) HYBRID DIGITAL MATRIX

(75) Inventors: Francis J. Chrnega, Yonkers, NY (US); Albert Thomas Dodrill, Pomona, NY (US); Glenn C. Waehner, Fresno, CA (US); David A. Rowe, Campbell Hall, NY (US)

Correspondence Address: Herbert W. Spencer III, 23629 Mill Valley Rd., Valencia, CA, 91355, US

(73) Assignee: ACUITY SYSTEMS INC, NEW WINDSOR, NY (US)

(21) Appl. No.: 12/751,887

(22) Filed: Mar. 31, 2010

Related U.S. Application Data
(60) Provisional application No. 61/165,074, filed on Mar. 31, 2009.

(51) Int. Cl. H04N 11/20; H04N 5/268

(52) U.S. Cl. 348/445; 348/706; 348/E05.057; 348/E11.021

(57) ABSTRACT

A video switching and control system is described that provides compatibility with conventional analog cameras while also accepting network IP type cameras. The system offers reduced control latency, improved recording efficiency, and more flexible display features with greatly improved performance and update rates.

The system offers greatly reduced wiring and installation complexity thus improving reliability. The architecture is scalable and expandable in either the analog camera count or the IP camera count. The system integrates these two camera technologies so that the camera source or recorder is transparent to the user. Each user can control all video sources, analog, IP, or recorded, from one keyboard and one or more monitors at each work station.

The unique all digital solution provides digital reliability and broadcast quality performance. The solution is significantly smaller and substantially lower cost the previous solutions, and offers higher monitor output capacity without the need for expensive down framing approaches currently used in the industry.

This application is related to and claims the benefit of U.S. Provisional Patent Application Ser. No. 61165074 filed Mar. 31, 2009, entitled Hybrid Digital Matrix, the entirety of which is incorporated herein by reference.

### BACKGROUND OF THE INVENTION

Analog matrix systems have been the backbone of larger video security systems for over 25 years. They can connect any camera input to any monitor viewing output, and provide pan tilt zoom control to movable cameras. They suffered from crosstalk between channels and sometimes limited the resolution of the camera by limiting the bandwidth. Noise, interference, and snowy images were other common problems. In general, many of these problems were caused by the chassis and backplane assembly that the individual cards connected to, and got much worse as the system size increased in either the number of cameras or monitors. Audio was not included in these early systems.

Matrix systems also suffered from fixed monitor capacity limitations, typically being limited to 16 or sometimes 32 viewing locations per system chassis. If one needed more monitors (viewing locations) than the basic matrix could support, you had to install a second or third complete system below the first one. This is generally called down framing. Down framing generally doubles or triples the physical size and cost of a system and the number of cables and connectors needed. This increases system installation costs and decreases reliability. Finally, these analog systems were also plagued with circuit board heating and drifting of analog circuit operating points. This caused performance to degrade over time and systems to need maintenance or tune ups periodically.

In recent years video systems have been installed using internet protocol and local area network (LAN) equipment to transmit the video signals from the cameras to the viewing locations. This provided great installation flexibility with simple CATV cables that are often already installed in the walls instead of Coaxial cables which must each be individually installed. Unfortunately, the advantages of this approach were often overshadowed by a variety of performance issues. These included long latency or image delays in the video channel making control of movable cameras very difficult and imprecise, and the inability to easily produce multi-screen displays in real time, as each viewing signal needed to be uncompressed and processed into a smaller tiled display format. In addition, the compression process often produced flaws and noticeable noise and processing artifacts that were not in the original image. Because of the difficulty and expense of compressing a camera image, the designer could often afford only one compressor circuit per camera. Thus, he had to select either low latency as needed by the live display, or high compression efficiency to give good recording efficiency and substantially reduce the cost of hard drives or similar digital image storage components. These digital storage systems were well liked because they offered instant recall and search for past events. Video tape could not provide this key feature. In the end, a compromise was often made to give moderate recording efficiency and also moderate image delay or latency.

These performance drawbacks caused many installations to install two systems at great expense: one being an analog matrix for low latency live camera viewing, and the second being a digital network system to provide the hard drive recording that gave easy search and editing. These two systems were not well integrated and two keyboards and two monitors were often needed by each operator, or two separate operators were used, one for live viewing and one for recorded viewing. A third system is sometimes used to provide audio functions including recording.

Finally, it was often desired to keep the existing analog cameras and use them, while adding IP cameras in areas where coax cables were not available and the network connection was the only possibility. Unfortunately, this hybrid approach often produced two separate systems with separate keyboards and monitors, causing difficulty for the users and guards. These problems have been overcome by the following design concepts.

### BRIEF DESCRIPTION OF RELATED TECHNOLOGY

There is a large installed base of analog CCTV cameras at large installations. There are not enough monitors to view all the cameras at once and camera outputs must be switched to selected monitors. Larger installations of down framed analog matrix switches have been used to connect large numbers of cameras to numerous monitors and to control the displays. The first commercial development of this technology was by American Dynamics which did not file for patents but used a trade secret approach to controlling their technology.

In recent years with the advent of digital technology digital video cameras have been developed that transmit video data using internet protocol. These are known as IP cameras. These cameras are connected through computers using what is called a “virtual matrix switch” where no actual matrix switch hardware is needed and cameras are selected by calling their individual addresses. Another trend has been to replace VHS tape with DVRs {digital video recorders} which require a digital video signal and preferably a compressed video signal. Current digital systems have significant draw backs in that switching from camera to camera can have 1 second periods of no video on the monitor, and the lag or latency between real time and the display time of the video signal can be as much as 2 seconds. This invention addresses both the delay in switching times and the lag delay while gaining the advantages of digital technology.

There are a variety of system topologies currently in use. They include the following:

### Traditional Analog Matrix

A true analog matrix system eliminates many of the above drawbacks in that without the buffering inherent in digital systems, true analog systems can offer zero latency and instant switch response time. Unfortunately, true analog systems suffer performance degradation as the system gets larger, and it is susceptible to noise and camera to cameras interference, often caused by the required backplane which carries multiple video signals.

Recording originally was done with VHS home video and VHS time lapse recorders. Today, large analog video matrix systems are often married to large compressed digital video recording systems, significantly increasing the installed cost. This technology is only offered by Pelco, Bosch, and AD, and despite being 95% of the market installed base and 65% of new orders, no new investments have been made to keep this analog matrix market segment alive. These systems only work with standard resolution analog cameras and do not work with IP digital VGA or megapixel cameras. Examples of companies providing these systems are American Dynamics, Bosch, Honeywell, and PELCO.

Hybrid systems are configured by combining an analog matrix with a digital IP based recording system. This gives the best of both worlds but does not look or behave like a planned fully integrated system. In general, a full analog matrix is provided and all or some of the analog inputs are also connected to Digital IP recoding systems servers and storage boxes. This combination provides a workable solution but has proven to be expensive and unreliable. Additionally, some systems are able to work with megapixel cameras, while others do not. Examples of companies providing systems are: American Dynamics, Bosch, Honeywell, and PELCO. As mentioned above, patents dealing directly with matrix switching for video are limited. There are patents dealing with switching but they are generally limited to data communication switches, particularly of multiplexed signals. An example is U.S. Pat. No. 7,339,939.

The Henley et al U.S. Pat. No. 6,754,439 discloses a video and audio switch for up to two MPEG inputs per switch with up to four digital outputs. U.S. Pat. No. 5,592,237 discloses using multiple high speed busses for a single camera system to facilitate multiple processing of mostly still images including input and output boards. The combination of the two does not lead to the invention of this patent where there is a minimum of 16 outputs for continuous viewing and control as can be handled from one matrix switch processing digital video data.

The Esbensen U.S. Pat. No. 7,124,427 B1 describes a methods and apparatus for an image surveillance system using a coordinator for control but does not contemplated the digital video and audio matrix switch of this invention. U.S. Pat. No. 7,633,520 (Samerasekera et. al.) describes a scalable architecture for providing real-time multi-camera distributed video processing and visualization. The system uses a matrix switcher but no details of the switch are provided.

The Acuity hybrid solution of this invention provides full IP flexibility and scalability, with shorter switching time and minimal latency, full update rate standard definition SD multi-screen displays on HD monitors, lower cost full performance work stations, smaller footprint, fully digital matrix connecting up to 16384 video inputs to 256 video outputs, instant keyboard response time, essentially no latency in live mode, flexible monitor choices with configurable HD Multi-screen or SD outputs, and is fully compatible with megapixel cameras.

### SUMMARY OF THE INVENTION

The hybrid matrix is comprised of a card cage that accepts conventional analog camera cards, IP camera cards, monitor display cards, image processing cards, and system expansion cards that can be employed in various quantities and combinations to create video systems.

The systems can grow in number of cameras supported by adding camera cards or expanding to additional bays (enclosures, matrix bay chassis). Various monitor displays can be configured with some monitors presenting full screen images, some SD format multi-screen displays, and some HD format multi-screen displays. Image analysis analytic tool cards can be employed, and audio can be included.

The system uses an all digital back plane concept that allows larger numbers of monitor channels to be accomplished in one bay compared to other traditional approaches. The back plane and video cards use a reduced number of digital signals through parallel to serial conversion and employ a display friendly 422 video format. The system performance is not degraded as numbers of cameras or monitors are increased.

The system is truly a hybrid as it can accept both analog and IP cameras and produces IP network outputs for each analog camera input for remote display and recording use. It results in a superior performing and cost effective system with reduced power and footprint needs.

### BRIEF DESCRIPTION OF THE DRAWINGS

A more complete understanding of the present invention, and the attendant advantages and the features thereof, will be more readily understood by reference to the following description when considered in conjunction with the accompanying drawings wherein.

FIG. 1. Bay is a drawing showing a typical bay (casing, enclosure for the invention);

FIG. 2. Back-Plane shows a typical configuration for the back-plane and the video busses on the back-plane (and alternate configuration is for the back-plane to be a mid-plane with cards from two sides);

FIG. 3. Camera Card shows a typical configuration for an analog camera card;

FIG. 4. IP Input Card shows a typical input card for IP cameras connect through Ethernet;

FIG. 5. Monitor Card show a typical configuration for an output card to display monitors;

FIG. 6. Analytic Process shows a typical card or module for processing video or audio data;

FIG. 7. Expander Card shows a typical card for connecting between bays;

FIG. 8. Basic Bay System shows the typical inputs and outputs from a bay;

FIG. 9. Two Bay System shows a the typical configuration for a two bay system;

FIG. 10. Seventeen (17) Bay System shows a typical configuration for a 17 bay system.

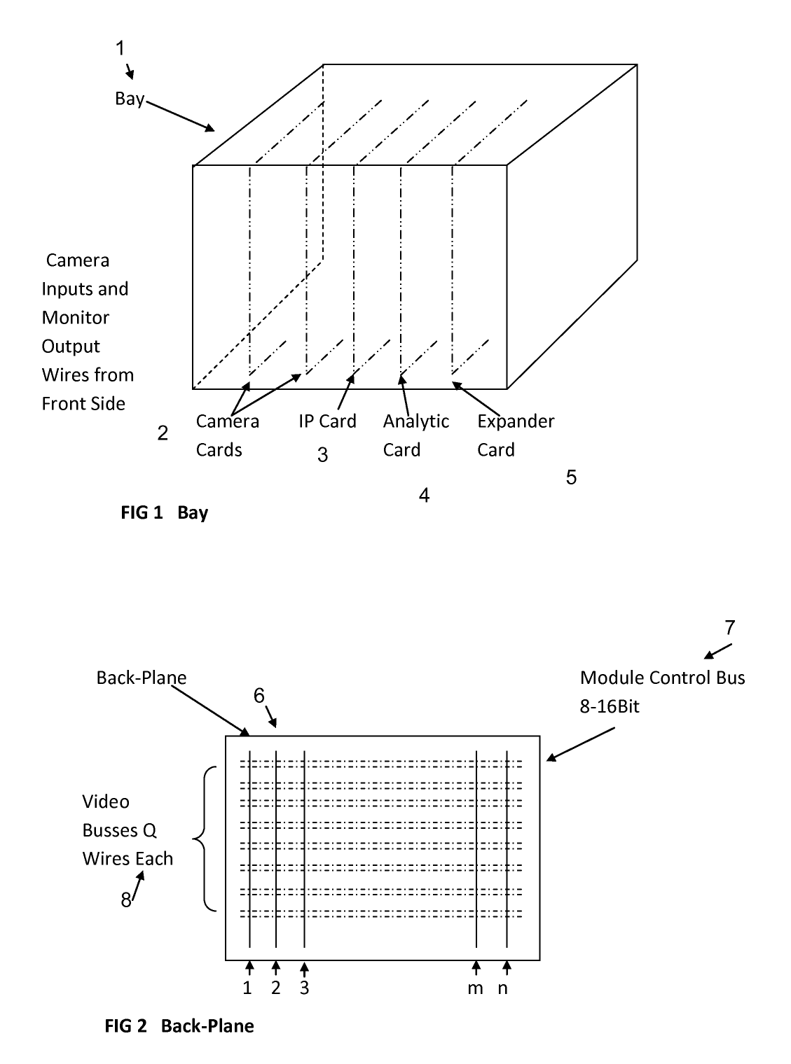

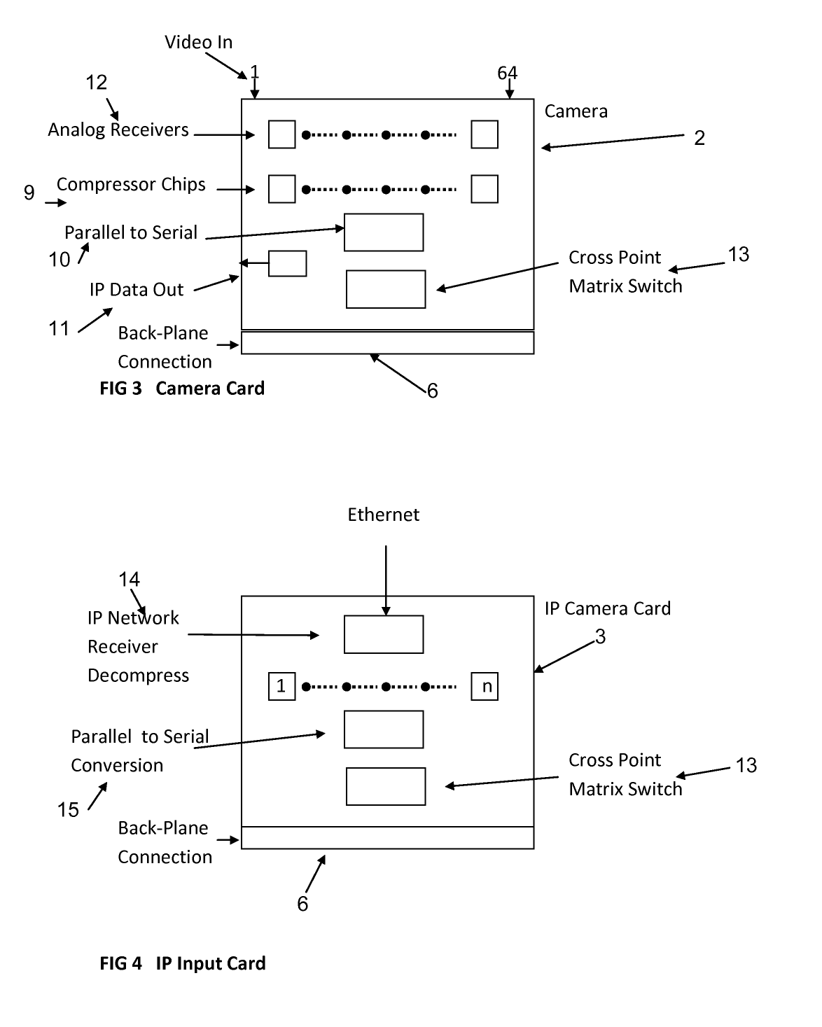

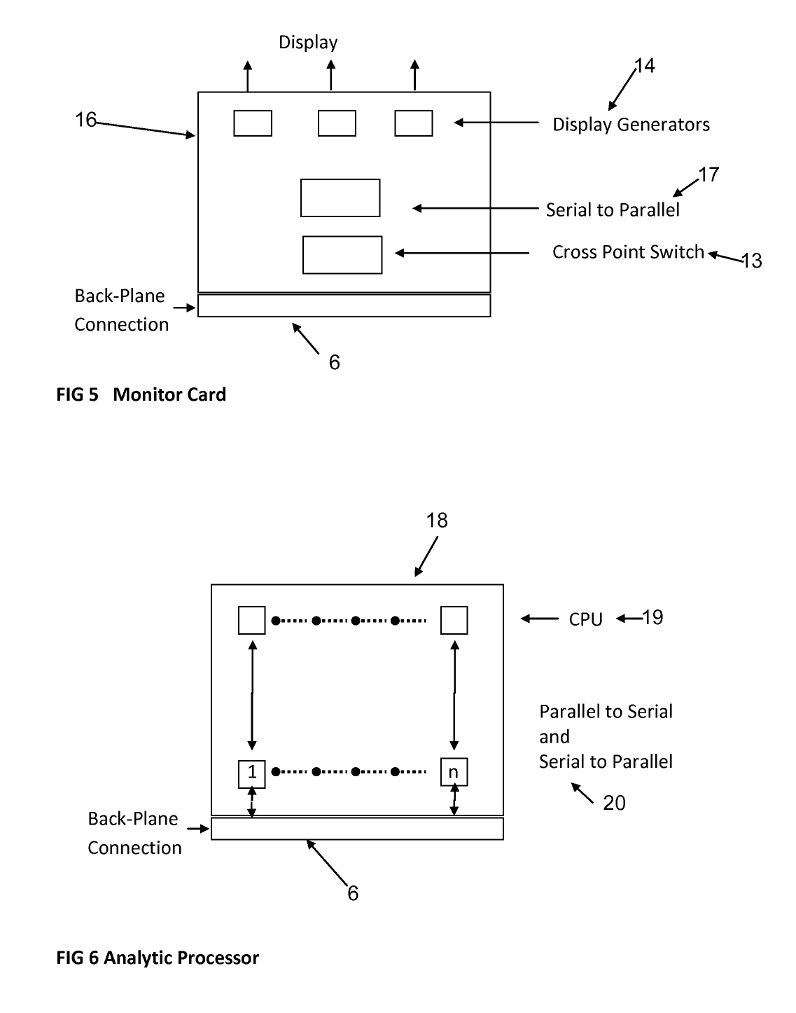

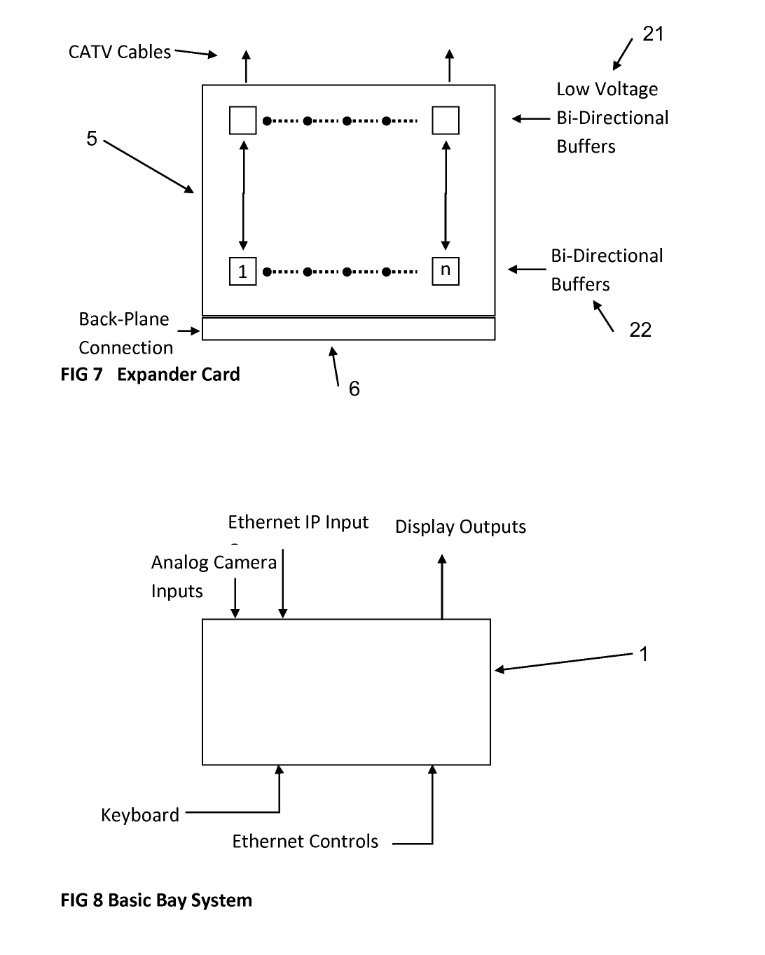

### DETAILED DESCRIPTION OF THE INVENTION

The system is comprised of an enclosure 1, also known as a bay, that can house a variety of video processing cards (2, 3, 4, 5, 16 & 18) and provide a means for the cards to communicate with each other. The bay contains a digital backplane 6, rather than a traditional analog back plane, to virtually eliminate the numerous noise and crosstalk and degradation issues that have plagued previous designs. The system uses a set of circuit cards that provide unique functions and features and can be installed in various quantities as the customer's application dictates. A key element of this system is the design of the digital backplane 6 that the various cards connect to, and the means by which the various cards access the bus 8 and present data to the bus 8. In addition, this unique design allows more cameras and more monitors to be processed in one bay 1, and also supports both traditional analog and IP type cameras as well as specialized analytic functions that can be performed on the video signals. Finally, the bay 1 is expandable or extendable to additional bays to produce very large systems. The bay or enclosure provide electrical power, has means of cooling. The bay has a control CPU to receive keyboard control commands to set up and control the modules, command specific cameras to be viewed on specific display devices, and communicate camera control and positioning and focus and other camera related information.

The camera cards 3 receive the Composite video input and digitize 12 it and produce a 656 format digital stream in the well known 422 format that can be easily scaled for multi screen displays. This digital signal is presented to a compression chip 9 that can produce one or more streams of compressed video in well known formats, typically one for low latency and fast response needed for live viewing, and one optimized for low cost recording. The recording stream can have a different rate, resolution, quality or format from the viewing stream. In the ideal embodiment the system will result in local display latency is less than 100 milliseconds for local live monitoring and less than 300 milliseconds for remote network live viewing. The compressed outputs of all the cameras on the card are combined or multiplexed or similar technique on a digital network 11, typically a LAN with Ethernet. However, other communication formats, such as optical or wired or wireless are possible to send this data. If a standard network is chosen, then the video can also be seen on remote workstations or at home over the internet. Thus, every analog camera will be available in compressed IP format on the network, along with any and all IP cameras for purposes of recording or viewing on remote network work stations. The analog camera module can provide a portion of the camera switching function and also digitizing and compressing one or more or all camera inputs and provide a network output for recording and or viewing of this compressed data in addition to switched video information to the back-plane or mid-plane digital video data busses.

The digitized videos on the camera card are also sent to digital parallel to serial converters 10. This can include the operation where 8 or 10 bit digital parallel video signals are converted to a lesser number of bits operating at higher speed to reduce wiring on the back-plane or mid-plane. These operations reduce the number of wires to carry the signal through the card and onto the back-plane or mid-plane and allows for digital switching equivalent to analog matrix switching. This reduction in number of wires is critical to achieving a large matrix switch as it makes LSI chip counts, connector pin counts, and backplane 6 wiring manageable. The digital architecture eliminates any chance of crosstalk, and provides broadcast quality video at all times, no matter how large the system. The switching 13 of a reduced number of signals per camera allows for larger camera arrays on each card, and also larger monitor arrays at the backplane. A 1024 by 64 or larger matrix is achievable in one bay. In the analog design, this number of cameras and monitors is physically impossible. In this way, the need for down framing is virtually eliminated, with dramatic savings in cables, connectors, hardware, cost, footprint, and power, to name just a few.

The back-plane or mid-plane 6 is located in a unit called a bay. There are multiple busses 8 on the back plane of the bay each corresponding to a monitor channel. All busses are available to each card and data can flow in either direction over each of the N independent busses on the backplane. Some video may flow one direction on one bus and in the other direction on another, as commanded by the bus system controller processor. Each digital data bus 8 communicates an individual video stream, so that every card on the bus can receive any of the videos on the busses, or can present video to the data bus. Cards or specific channels on cards not involved in a particular video channel do not read or place information on a camera bus and act as if they are not there. An additional separate digital bus 7 is included to present commands from the bay controller to specific cards commanding them to use the appropriate monitor channel bus. The back-plane or mid-plane has bidirectional buffers between selected card locations. The back-plane or mid-plane of the switch can accept video processing cards that perform analytical processing of the digital video signals. The digital video signals on the back-plane or mid-plane are low voltage differential signals are available to each card location for processing or display. The back-plane or mid-plane can be designed to have pluggable cards.

The signals on the backplane can be normal logic signals. However, low voltage differential signals provide the best performance and are directly compatible with the expander cards and the associated CAT V wiring between bays 1.

Typically cards or modules will be plugged into the back-plane or mid-plane 6. In the case of a mid-plane, cards are plugged in from both sides while with a back-plane they are on one side. it is to be understood that modules or cards can be hard connected to the back plane or employ connectors to allow card changes.

A unique feature of the camera card 2 is its input structure. By providing differential inputs all terminated at 110 ohms, CATV or similar twisted pair cable can be accommodated. This is the most common wiring used today, in both large casinos and smaller facility applications. The connectors for this type of cable are very small and efficient, and allow many more cameras to connect to the camera 5 chassis than would be possible with standard BNC connectors, which almost all competing systems use. If one has older coaxial cables with BNC connectors, they can be connected to a passive connection panel which has BNC connectors and RJ45 CATV connectors directly adjacent. In addition, the input BNC has a 270 ohm partial termination resistor connected across the input cable. This resistor, combined with the 110 ohm resistor at the input, produces a total termination of 75 ohms as required by the coax cable. The single ended coax signal is completely compatible with the differential inputs, as they read the signal on the cable perfectly and also provide an additional benefit of common mode rejection.

The IP camera card 3 receives IP camera signals via CAT V Ethernet connections to the card and decodes as many compressed camera signals 14 as there are monitor busses on the backplane in the system. A typical IP camera card will have a parallel to serial converter 15 and a cross point matrix switch 13. Thus, all IP cameras can be full update rate to create superior output displays. This module can receive compressed network signals in a network module and decompressing the data and converting it to 656 or similar format and converting this bit stream to a fewer number of bits for transmission by the individual channels of the digital back plane for receipt by the appropriate modules. Decoding as many channels of compressed video as can be accommodated by the back-plane or mid-plane (typically 32 or 64), so that all displayed network images can be displayed or sent via the expansion modules in real time or as fast as presented by the individual cameras.

The expander card 5 allows all the digital video signals on the backplane to be communicated to other backplanes to allow additional cameras from other bays to be added to the system that is where an expander board connects the digital back plane signals to other similar bays to accommodate additional video modules to expand video input or processing capacity. Low voltage differential signaling from the backplane is directly compatible with the CAT V wiring between bays. The expander card will typically have low voltage bi-directional buffers 21 and bi-directional buffers 22. However, other interbay communication means are possible.

One chassis can accommodate 1024 cameras or more using this technique. By using an expander card, digital video can be sent to another bay and an additional 1024 cameras can be added. If many bays are to be included in the system, multiple expander cards can be inserted into one bay to collect video from up to 16 bays. This configuration acts as a final 16 to 1 selector creating the 16384 camera system. A display module 16 inserted into this collector or output bay will be able to display any of the 16384 cameras on any of the 64 monitors. Throughout this process the video has remained totally digital and never passed through more than two bays before being displayed, thus allowing the system to grow in the camera direction very gracefully without changing the performance or features of the system. The monitor direction is limited only to the monitor capacity of the input chassis and its back-plane or mid-plane, typically 64 but extending to 256 if needed. The user can employ less than the maximum number of monitors, and simply install fewer communication channels. Different size camera and monitor cards and bay chassis can also be designed to accommodate smaller systems.

The IP input cards 3 receive Ethernet signals and decode as many cameras as there are back plane monitor channels. All Ethernet data selection and switching prior to the actual IP card is performed by standard network switching and routing gear external to the bay as known to one skilled in the network art. The IP card de-compresses 14 each selected input and brings it back to 656 formats or a similar digital format or the designer's choice, uses the previously described parallel to serial process 10, followed by a digital switch 13, so that the backplane signals are identical regardless of transmitting analog or IP camera signals. Some monitor channels being viewed can be IP while others can be analog, thus being seamlessly integrated in one system.

Another card 18 in the system can contain multiple signal processors to perform electronic analysis of any video present on the backplane. These analytic tools provide improved operator efficiency and are well known to those skilled in the art. However, deploying multiple analytic tools through additional cards in a bay is unique. This card will have a CPU 19 for processing and Parallel to Serial and Serial to Parallel processors 20 for supplying data to and from the back plane to the CPU 19 for processing.

In addition to video, an audio receiving card can be used in the bay and send the data on one of the N video data busses to a monitor card with additional audio capability. The monitor output cards 16 have all the backplane signals available to them and can create full screen displays or multi-screen tiled displays in SD and HD formats using display generators 14. A cross point selects the data for the out puts from the back-plane and a serial to parallel convert 17 provide s data to the display generators 14. The use of the 422 digital format greatly simplifies the creation of multi-screen displays as the signals can be dimensionally shrunk without color decoding issues well known to those skilled in the art.

The short latency JPEG or similar compressed streams can be best used for the live display at remote network viewing stations. The most efficient but longer latency compressed streams are routed to a separate recorder chassis that sends the numerous camera inputs to a hard drive or similar digital technology storage array for recording. The short latency stream could also be sent to the recorder for a second recording path or special processing. Since the two streams can be different field or frame rates, the shorter latency but typically higher update rate stream could be used for short term continuous pre-alarm and post-alarm storage, and the slower frame rate high compression efficiency streams used for long term recording. A short term stream can be recorded for a few hours for instant recall of a critical event, and the long term stream recorded for weeks, due to its higher recording efficiency. During the recording period of the shorter stream, which is user selectable, both streams will be independently recorded for redundancy. The compressed video data storage medium is normally hard drives, but other storage technologies can be used.

Unique features are as follows: Using a totally digital back-plane 6 with individual busses 8 corresponding to monitor outputs and all video modules having access to the bus to either view video or present video to the bus. Bi-modal front end with both twist and Coax properly received and terminated. Digitizing the video immediately and using for both live non-compressed and compressed. Carrying broadcast 4:2:2 data through the switch for later multi-screen display use. Parallel to serial up-converting the digital video to reduce the switch complexity. Designing the switch for a large monitor count, regardless of actual system size to avoid down framing. Using CAT V or similar cable to interconnect bays but not using Ethernet.

A feature of the system is the ability to expand the camera count with a purely digital switch between the camera cards and the display modules. Another feature of the system is the ability for down converting the video back to 4:2:2 for easy display use dimensional scaling; decoding the compressed or recorded video to 4:2:2 to be compatible with the matrix channel and additional feature is offering selectable display modules for various display types or multi-screen displays.

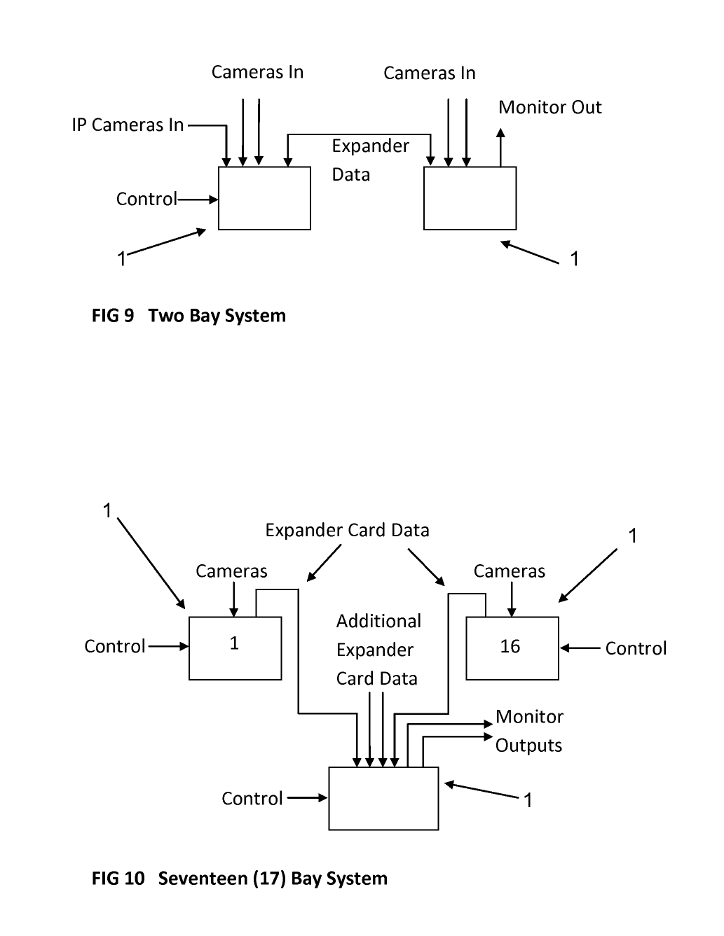

Examples of a single bay configuration, a two bay configuration and a seventeen bay configuration are shown in FIGS. 8, 9 and 10. These FIG. 10 show how to use multiple expansion modules in one bay to collect digital video camera data from multiple bays for analysis and display of larger numbers of cameras. The bays can support multiple display modules and having different types of display modules in one or more bays to create multiple numbers of displays and options as to types of displays.

Another aspect of the invention is making the back-plane or mid-plane not as tall as the bay producing a slot at the bottom or top of the rear of the bay to facilitate the natural convective flow of cooling air into or out of the front of the bay, where cool air can enter at the bottom of the back-plane or mid-plane and exit from the top of the front panel (natural convection to the other end)

In summary, this invention is a video camera switching system that consist of a bay or bays with multiple modules of different types that receive, process, display, and transmit video data. The video data is digitally passed through a digital back-plane or mid-plane that can handle a minimum of 16 cameras either analog or IP or a combination of IP or analog cameras and provide outputs for a minimum of 16 monitors. Analog camera signals are converted on the input card to digital signals. Each camera signal can be switched to any display output or to any signal processor available on the back-plane or mid-plane digital data bus. The back-plane or mid-plane has multiple independent bidirectional digital data busses equal in number to the maximum number of output monitors. A module communication technique where multiple channels of digital video information are available on the back-plane or mid-plane and data can be read from or presented to individual video channels present on the back-plane or mid-plane. The system can be expanded to also process audio signals and to include means for synchronizing audio signals with video.

The description above is not intended to convey every detail and concept in this disclosure. It is clear to those skilled in the art that the concepts disclosed represent preferred embodiments and may be adapted to other hardware and configurations to accomplish the desired end result of the claims.

What is claimed:

1. A video camera switching system that consist of a bay or bays accepting multiple modules of different types that receive, process, display, and transmit video data. The video data is digitally communicated between the installed modules through a digital back-plane or mid-plane that can pass a minimum of 32 cameras either analog or IP or a combination of IP or analog cameras and provide display outputs for a minimum of 16 monitors.
Analog camera signals are converted on the input card to digital signals. Each camera signal can be switched to any display output or to any signal processor connected to the back-plane or mid-plane digital data bus. The back-plane or mid-plane has multiple independent bidirectional digital data busses equal in number to the maximum number of output monitors. A module communication technique where multiple channels of digital video information are available on the back-plane or mid-plane and data can be read from or presented to individual video channels on the back-plane or mid-plane.

2. In claim 1 camera digital signals are converted to the standard 656 video format

3. In claim 1 analog camera signals are converted into at least two streams one compressed for low latency display and one compressed for efficient storage.

4. In claim 1 where the resulting local display latency is less than 100 milliseconds for local live monitoring and less than 300 milliseconds for remote network live viewing

5. In claim 1 where 8 or 10 bit digital parallel video signals are converted to a lesser number of bits operating at higher speed to reduce wiring on the back-plane or mid-plane.

6. The system in claim 1 where an expander board connects the digital back plane signals to other similar bays to accommodate additional video modules to expand video input or processing capacity

7. The back-plane or mid-plane of claim 1 has bidirectional buffers between selected card locations.

8. The back-plane or mid-plane of the switch of claim 1 can accept video processing cards that perform analytical processing of the digital video signals.

9. In claim 1 the digital video signals on the back-plane or mid-plane are low voltage differential signals which are available to each card location for processing or display.

10. The back-plane or mid-plane claim 1 is designed to have pluggable cards.

11. In claim 1 a mechanical enclosure (matrix bay chassis) that can accept a variety of video related plug in modules and communicate this video information between the modules. The assembly can accommodate traditional analog video camera modules, IP network modules receiving network signals carrying compressed video information, video analysis modules to monitor and alert the user to specific types of events in the camera images received by the assembly, display modules to present the video information transmitted between the modules on display devices, and expansion and data receiving modules to allow multiple such enclosures to be connected together to create larger systems to accommodate additional modules.

12. In claim 1 an enclosure containing a means of providing electrical power to the various modules, a cooling means as required by the modules, and a control CPU to receive keyboard control commands to set up and control the modules, command specific cameras to be viewed on specific display devices, and communicate camera control and positioning and focus and other camera related information.

13. In claim 1 The individual modules can either present selected video information to one or more individual channels on the back-plane or mid-plane (by the selected source) or listen and observe the video data for analysis and output of the processed result on a different channel, or listen and output to a display device, or serve as an input or output device per channel for transmission or receipt of data from other such assemblies (other matrix bays).

14. In claim 1 the bay communication method between the modules that is digital and converted to a higher frequency and lower number of bits per camera channel than the basic 8 or 10 bit video data stream formats.

15. In claim 1 an analog camera module providing a portion of the camera switching function and also digitizing and compressing one or more or all camera inputs and providing a network output for recording and or viewing of this compressed data in addition to switched video information to the back-plane or mid-plane digital video data busses.

16. In claim 1 a camera module providing multiple compressed camera video streams where as a minimum the recording stream is different in rate, resolution, quality, or format from the viewing stream.

17. In claim 1 a display module that receives the digital back plane data and down converts it for presentation in a more standard parallel form for conversion to a displayable live video format.

18. In claim 1 a display module receiving the back-plane or mid-plane data that can present the video data in single image full screen format (both HD and or SD) and as an HD format tiled multi-image presentation.

19. In claim 1 an expansion module that listens to the back-plane or mid-plane data for transmission to other bays, or receives data from other bays for insertion onto the back-plane or mid-plane for analysis, display, or further selection.

20. In claim 1 using multiple expansion modules in one bay to collect digital video camera data from multiple bays for analysis and display of larger numbers of cameras.

21. In claim 1 using multiple display modules and having different types of display modules in one or more bays to create multiple numbers of displays and options as to types of displays.

22. In claim 1 making the back-plane or mid-plane not as tall as the bay producing a slot at the bottom or top of the rear of the bay to facilitate the natural convective flow of cooling air into or out of the front of the bay, where cool air can enter at the bottom of the back-plane or mid-plane and exit from the top of the front panel (natural convection to the other end)

23. In claim 1 receiving compressed network signals in a network module and decompressing the data and converting it to 656 or similar format and converting this bit stream to a fewer number of bits for transmission by the individual channels of the digital back plane for receipt by the appropriate modules. Decoding as many channels of compressed video as can be accommodated by the back-plane or mid-plane (typically 32 or 64), so that all displayed network images can be displayed or sent via the expansion modules in real time or as fast as presented by the individual cameras.

24. In claim 1 where video data from multiple bays is connected to one or more bays to form larger systems

25. A video camera switching system that consists of a bay or bays containing multiple modules of different types that receive, process, display, and transmit video data. The video data is digitally passed through a digital back-plane or mid-plane that can handle a minimum of 32 cameras either analog or IP or a combination of IP or analog cameras and provide outputs for a minimum of 16 monitors.

26. In claim 25 camera digital signals are converted to the standard 656 video format

27. In claim 25 analog camera signals are converted into two streams one compressed for low latency display and one compressed for efficient storage.

28. In claim 25 where the resulting local display latency is less than 100 milliseconds for local live monitoring and less than 300 milliseconds for remote network live viewing

29. In claim 25 where 8 or 10 bit digital parallel video signals are converted to a lesser number of bits operating at higher speed to reduce wiring on the back-plane or mid-plane.

30. In claim 25 where an expander board connects the digital back plane signals to other similar bays to accommodate additional video modules to expand video input or processing capacity

31. The back-plane or mid-plane of claim 25 has bidirectional buffers between selected card locations.

32. The back-plane or mid-plane of the switch of claim 25 can accept cards that perform analytical processing of the digital video signals.

33. In claim 25 the camera digital signals on the back-plane or mid-plane are low voltage differential signals which are available to each card slot for processing or display.

34. The back-plane or mid-plane claim 25 is designed to have pluggable cards.

35. In claim 25 a mechanical enclosure (matrix bay chassis) that can accept a variety of video related plug in modules and communicate this video information between the modules. The assembly can accommodate traditional analog video camera modules, IP network modules receiving network signals carrying compressed video information, video analysis modules to monitor and alert the user to specific types of events in the camera images received by the assembly, display modules to present the video information transmitted between the modules on display devices, and expansion and data receiving modules to allow multiple such enclosures to be connected together to create larger systems to accommodate additional modules.

36. In claim 25 an enclosure containing a means of providing electrical power to the various modules, a cooling means as required by the modules, and a control CPU to receive keyboard control commands to set up and control the modules, command specific cameras to be viewed on specific display devices, and communicate camera control and positioning and focus and other camera related information.

37. In claim 25 The individual modules can either present selected video information to one or more or no individual channels on the back-plane or mid-plane (be the selected source) or listen and observe the video data for analysis and output of the processed result on a different channel, or listen and output to a display device, or serve as an input or output device per channel for transmission or receipt of data from other such assemblies (other matrix bays).

38. In claim 25 the bay communication method between the modules that is digital and converted to a higher frequency and lower number of bits per camera channel than the basic 8 or 10 bit video data stream formats.

39. In claim 25 an analog camera module providing a portion of the camera switching function and also digitizing and compressing one or more or all camera inputs and providing a network output for recording and or viewing of this compressed data in addition to switched video information to the back-plane or mid-plane digital video data busses.

40. In claim 25 a camera module providing multiple compressed camera video streams where as a minimum the recording stream is different in rate, resolution, quality, or format from the viewing stream.

41. In claim 25 a display module that receives the digital back plane data and down converts it for presentation in a more standard parallel form for conversion to a displayable live video format.

42. In claim 25 a display module receiving the back-plane or mid-plane data that can present the video data in single image full screen format (both HD and or SD) and as an HD format tiled multi-image presentation.

43. In claim 25 an expansion module that listens to the back-plane or mid-plane data for transmission to other bays, or receives data from other bays for insertion onto the back-plane or mid-plane for analysis, display, or further selection.

44. In claim 25 using multiple expansion modules in one bay to collect digital video camera data from multiple bays for analysis and display of larger numbers of cameras.

45. In claim 25 using multiple display modules and having different types of display modules in one bay to create multiple numbers of displays and options as to types of displays.

46. In claim 25 making the back-plane or mid-plane not as tall as the bay producing a slot at the bottom or top of the rear of the bay to facilitate the natural convective flow of cooling air into or out of the front of the bay, where cool air can enter at the bottom of the back-plane or mid-plane and exit from the top of the front panel (natural convection to the other end)

47. In claim 25 receiving compressed network signals in a network module and decompressing the data and converting it to 656 or similar format for use by the display modules. Decoding as many channels of compressed video as can be accommodated by the back-plane or mid-plane (typically 32 or 64), so that all displayed network images can be displayed or sent via the expansion modules in real time or as fast as presented by the individual cameras.

48. In claim where video data from multiple bays is connected to one or more bays to form larger systems

49. In either claim 1 or claim 25 where analog input cards include differential inputs terminated at 110 ohms and connect to BNC assemblies that have an additional 270 ohm termination.

50. Video camera switching system that consist of multiple modules of different types that receive, process, display, and transmit video data. The video data is digitally passed through a digital back-plane or mid-plane where the IP camera input card or multiple cards have separate decoders for each camera where the total number of decoders equals the number of output display channels and having a separate bus on the back-plane or mid-plane for each monitor channel, with a minimum of 16 monitors.
